(19) United States
(12) Patent Application Publication
(10) Pub. No.: US 2006/0031821 A1
(43) Pub. Date: Feb. 9, 2006

(54) Divided compiling program application functionality for software development

(76) Inventor: Budd J. Rutter II, Wayzata, MN (US)

Correspondence Address: E. J. Brooks & Associates, PLLC, Suite 500, 1221 Nicollet Avenue, Minneapolis, MN, 55403, US

(21) Appl. No.: 10/911,377

(22) Filed: Aug. 4, 2004

(51) Int. Cl. G06F 9/45

(52) U.S. Cl. 717/140

(57) ABSTRACT

Embodiments of the present invention relate to methods and systems for dividing compiling program application functionality between computing devices for software development. One device embodiment includes a processor, memory, and program instructions. The memory is coupled to the processor. The program instructions stored in memory and executable by the processor to receive a data set and a selection of options regarding how the data set is to be compiled from a second device. Program instructions are also provided to compile the selected data set based upon the selection of options.

### FIELD OF THE INVENTION

Embodiments of the present invention relate to methods, devices, and systems for dividing compiling program application functionality between computing devices.

### BACKGROUND OF THE INVENTION

In the creation of computer program applications there are functions during the development process that can take substantial time and computer resources to achieve. For example, compiling the raw code of program instructions into a program application can take significant time and resources to complete.

Program applications are typically designed for use with a particular operating system. Examples of different operating systems include, but are not limited to: z/OS, OS/390, VSE/ESA, z/VM, AIX, and Microsoft Windows, to name a few.

Additionally, various types of computing languages can be used independently or in combination to create a program application. Examples of programming languages include: Java, C, C++, COBOL, PL/I, Enterprise Generation Language (EGL), CA-Optimizer, and FORTRAN, among others.

A compiling function is one such function that is used in designing program applications. The compiling function occurs during the development process and is used to translate code written by a developer into computer executable instructions. Compiling functions require a different amount of resources for each program application that is being designed depending upon a number of factors. For example, the program application's length, complexity, operating system on which it is to be used, and the program language in which the application is written, among others, are all factors that can determine the amount of resources the compiling function will take.

In order to reduce the time needed to achieve the development of a program application, software developers have developed program applications to aid in compiling program applications. However, these processes can still demand substantial resources, especially, since program applications are generally continuing to become more complex and are continuing to increase in size.

In efforts to further reduce the time used to perform program application functions during the compiling process, the program applications used to aid in the compiling process are either run in parallel, using shared memory multiprocessors to accelerate a single phase of the application's functionality, or source files are independently operated on, such as to compile each file into an associated executable followed by a sequential linkage of binary program instructions into a single executable.

However, compilation via acceleration of a single compilation phase on a shared memory multiprocessor, for example, is sometimes suitable for research purposes, but is generally not applicable to decreasing the entire compilation or incremental recompilation delay. Further, compilation of each file of a multi-file program in isolation does not allow for the flow of information between files to yield a more optimal executable. These solutions still require a developer to used significant resources to accomplish the compiling of a program.

In many cases, developers working are doing their development work on large scale computer systems. These systems have typically been designed to manage a network of computers within a company and handle a wide variety of generally small tasks for the users within the company. However, the compiling of programs in development are in many instances large computing jobs and the computer system may have to allocate substantial resources for the compiling of programs in development that may be needed for the functioning of their computer systems.

Additionally, the compiling program applications used to aid the developer are often leased, or seat licenses are purchased. Oftentimes, the licenses are based upon the processing speed of the system or of a particular processor, such as the Central Processing Unit (CPU).

For example, in many cases, license rates are determined based upon the number of Millions of Instructions Per Second (MIPS) or Millions of Service Units (MSUs) of a particular processor. For instance, a processor can have a capacity of 60 MIPS, but the use attributable to the compiler is only 15 MIPS. In such situations, the license rates can be such that the use of the compiling program applications is not economical or such that the developer cannot afford to use the compiling program applications.

### BRIEF DESCRIPTION OF THE DRAWINGS

FIG. 1 illustrates a system embodiment for dividing the execution of compiling program application functions.

FIG. 2 illustrates another system embodiment for dividing the execution of compiling program application functions.

FIG. 3 illustrates a method embodiment for dividing the execution of compiling program application functions.

FIG. 4 illustrates another method embodiment for dividing the execution of compiling program application functions.

### DETAILED DESCRIPTION OF THE INVENTION

Embodiments of the present invention relate to methods, devices, and systems for dividing the execution of program application functions for use in the compiling of executable instructions for software program applications. Embodiments of the present invention allow selection of a number of options to be made, through a user interface, regarding the compiling of a program application. This information can then be sent to a second computer on which the compiling of the software program application can be accomplished.

In this way, the compiling can be done on a smaller computing device or system. This can free up the resources on the large computing system that a developer would have used to compile a program application thereon. Since the compiling can be accomplished on a smaller and/or less powerful device or system (having less MIPS and/or MSUs) the amount paid to access the program can also be reduced.

Embodiments of the present invention include, for example, device embodiments having a processor, memory coupled to the processor, and program instructions stored in memory and executable by the processor. Program instructions can include instructions to receive a data set from a remote device and a selection of options regarding how the data set is to be manipulated, made through a user interface on the remote device, among others. Device embodiments can also include program instructions to manipulate the selected data set based upon the selection of options made through the user interface.

Embodiments of the present invention are applicable for use with any compiling program application functionality used by a developer when developing a program application. Compilation is typically accomplished through use of program applications called compilers. A compiler is software (i.e., one or more program applications) that converts a set of high-level language statements (e.g., high level programming language such as C/C++, one of the various types of COBOL, etc.), that are more easily understood by a developer, into a lower-level representation, that is understood by a computing device (e.g., machine language).

For example, compiling program applications can translate a program application written in a high-level programming language (C/C++, COBOL, etc.) into machine language or, in some cases, into assembly language and then into machine language. A program application can be written as a single block of programming code, but in many cases, a program application is programmed in the form of a number of modules. Once the modules are translated into machine language, a utility known as a “linker” or “linkage editor” then combines all machine language modules to be used in the program application into an executable program that can run in a computing device.

In such compiling program applications, the developer uses a user interface to interact with and operate the compiling program application. In various embodiments of the present invention, the user interface is installed on the developer's computing device or system and is used to operate the compiling program application. The other components of the compiling application program, such as those that provide the actual compiling function for compiling the data, can be installed on a second computing device. In this way, the developer can still use the developer's computing device to operate the compiling functionality even though the actual compiling function is done on a different computing device or system.

In various embodiments of the present invention, program instructions can be provided on the first and/or second computing devices to allow the operation between the user interface and the other components to be seamless and transparent to the user. In this way, the user has the perception that the entire compiling program application is resident on their computing device when in actuality some of the components are on a remote computing device and their data is transferred to a remote device for manipulation. This configuration allows for less space and processing resources to be used to store the compiling program application and allows the manipulation of the data to be accomplished on a computing device other than the device the developer is using.

Such embodiments can allow for resources on a developer's computing devices, for example, to be conserved since the compiling can be accomplished on another computing device. In some embodiments, the computing device providing the actual compiling functions can be specialized for providing compiling functionality and, therefore, a smaller and/or less expensive computing device than those of the developer's requesting the compiling can be used.

Additionally, the computing device providing the compiling functionality can be shared by a number of developers and therefore, each developer does not have to have the full compiling program application on their computing device. Such embodiments can also result in a cost savings for developers.

In various embodiments, a full compiling program application, such as an off the shelf compiler can be provided on the second computing device. In such embodiments, a user interface can be created that mimics the actual user interface provided with the off the shelf program application and can be placed on the first device. In this way, the off the shelf program application may not have to be modified or may only require minimal modification.

In various embodiments, program instructions can be provided such that the user does not realize any difference in the functionality of the compiling program application. The computing system can be created for example, such that the user interface on the second computing device is bypassed by the mimic user interface. In such embodiments, the developer uses the mimic of the user interface on the first device to operate the compiling program application on the second device.

As stated above, various embodiments of the present invention can allow the selections of options to be made on one device and the selected options and the data to be compiled can then be sent to a second device for the compilation of the data to be accomplished. In this way, the compilation of data can be moved to a computing device, for example, that has a smaller number of users or is using less MIPS and/or MSUs and, therefore, the calculation of the cost of use for purposes of licensing can be less.

Additionally, this also allows a third party to provide the compiling program application at a remote site and developers can access the application remotely, for example, by sending their data to the remote site for processing in a manner that is transparent to the developer. This also allows a second computing device to include a number of compiling program applications for use by a developer where the first computing device used by the developer could not hold or process all of the compiling program applications or functions. This is particularly advantageous when developers are using personal computers or terminals that have limited ROM or RAM available.

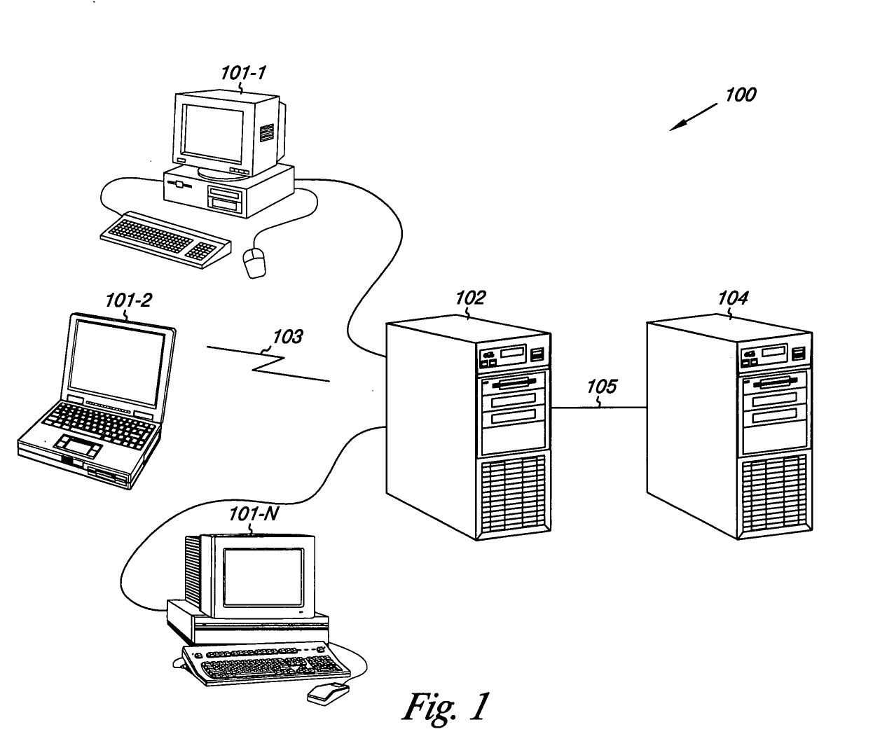

FIG. 1 illustrates a system embodiment for dividing the execution of program application functions. In FIG. 1, the system 100 includes a network having a number of personal computing devices 101-1 to 101-N, a number of first servers 102, and/or a number of second servers 104. Computing devices herein include devices having one or more processors and a memory for processing program instructions and data.

In the embodiment shown in FIG. 1, the number of personal computing devices 101-1 to 101-N can be devices used by a developer to access the network 100 for use of a compiling program application resident thereon, such as resident on server 104. In such embodiments, the personal computing devices include a user interface for use by the developer.

Those of ordinary skill in the art will understand that the compiling program application can reside on any device, including devices 101-1 to 104 shown in FIG. 1. These computing devices can also be used by developers to hold a portion or all of the data needed for a compiling function. For example, the computing device 101-1 can include source code, code in assembly language, object code, libraries, listings, and the like.

In the embodiment shown in FIG. 1, first server 102 is a network server and provides functionality and storage for the network to which computing devices 101-1 to 104 are connected. In various embodiments, such as that shown in FIG. 1, many of the network's functions can be provided by the network server, such as computing device 102. Another server, such as computing device 104, can be used to provide a number of compiling program applications for use by the network users. As stated above, the network can be a public or private network.

In the embodiment shown in FIG. 1, computing device 104 is a server that is dedicated to the processing of compiling program application functions. In this way, the resources of other devices in the network can be allocated to other tasks.

Additionally, in such an arrangement, the network provider can choose to optimize its network by selecting a computing device that is specialized for manipulating data for use as computing device 104. Specialized computing devices for example, can include devices having extra ROM and/or RAM for storage of data and/or processing of development functions (e.g., a compiling function), and/or devices with faster processors for more quickly access and processing data.

As shown in FIG. 1, computing devices can be connected in various manners. For example, computing devices can be connected via wireless 103 or wired 105 connection mediums. Computing devices 101-1 to 104 can be any type of computing device including devices such as terminals and personal computers (PCs), servers, and mainframes, to name a few. Those of ordinary skill in the art will appreciate from reading this disclosure that the network can contain as few as two devices, with one device having the user interface functionality and the other device having a number of other compiling functions thereon.

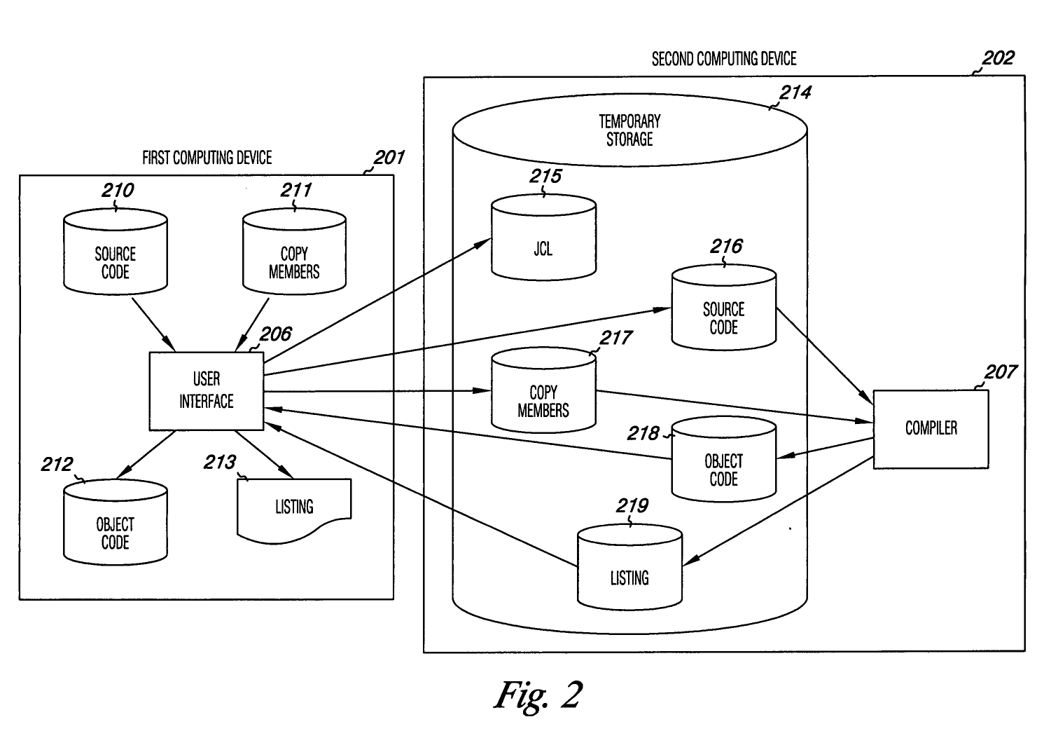

For example, FIG. 2 illustrates another system embodiment for dividing the execution of compiling program application functions. In this embodiment, two computing devices 201 and 202 are shown and described. In the embodiment shown in FIG. 2, first computing device 201 includes a processor and memory with instructions stored therein and executable on the processor to provide a user interface 206. As stated above, the user interface 206 allows the user of the first computing device 201 to operate a compiling program application on the second computing device 202. When using the user interface 206, the user can access source code 210, copy members 211, object code 212, and listing files 213, among others.

These files 210-213 are typically stored in memory on the computing device 201. However, the embodiments of the invention are not so limited. When the user initiates a compiling function that resides on the second computing device 202, program instructions locate the information needed to accomplish the compiling function and transfer the request to initiate the compiling function and the relevant data to the second computing device 202 (e.g., from memory on the first computing device 201).

Once transferred, the data can be stored in memory, such as temporary memory 214 for use during the compiling function. Those of ordinary skill in the art will understand that the data can either be moved from the first computing device 201 to the second computing device 202 or a copy of the data can be made on the second computing device 202.

As an example of the processing of a compiling function, in the embodiment shown in FIG. 2, a compiling function is to be carried out by the system. A request to compile data stored in memory on the first computing device 201 is provided to the user interface 206 and program instructions execute to locate the data to be compiled. Data can include source code 210, copy members 211, object code 212, and listings in listing file 213, among other types of data used in such processes. In some cases, for example, the source code of the program application to be compiled will have to be searched to identify if there is any additional source code data, that is referenced in the program application to be compiled, that has to be provided to the compiler.

Once the data is located, the data can be transferred to the second computing device 202. The transfer can be accomplished by any transfer mechanism that will transfer the data from one computing device to another, such as by a File Transfer Program (FTP), for example. The FTP in this embodiment would include the options specified by the developer, the source code, and any data or other necessary files.

Further, in some embodiments, a Job Control Language (JCL) program can be created to aid in the execution of the compiling function. In such cases, the JCL can be included in the FTP and the FTP can also include instructions for returning system messages regarding the running of the JCL to the developer's computing device. The FTP can also include instructions for handling the output of the compiling function. For example, instructions can be provided for displaying the output on the developer's device, for returning the output to the developer's computing device and other such functions.

Once the information has been transferred to the second computing device, is can be stored until the compiling process commences. In various embodiments, the storage 214 in the second computing device 202 can include independent areas for storing the different types of data transferred from the first computing device 201. For example, storage 214 can include areas for source code 216, copy members 217, object code 218, and a listing file 219, among others.

Storage 214 can also include one or more Job Control Language (JCL) files 215. These JCL files include instructions for performing functions on the second computing device 202. The JCL files can include instructions for performing one or more processing functions such as compiling, linkage editing, simulating, executing, and the like. The JCL files resident on the second computing device can be those sent from the first computing device discussed above, among others. As such, the JCL files can be initiated based upon the selections made on the user interface and/or can be initiated based upon program instructions within the second computing device 202.

Based upon the information provided from the first computing device 201, a compiling function can be selected and initiated on the second computing device 202. The data from the first computing device 201 can be preloaded to the second computing device 202 or transferred on an as needed basis as the compiling program is running. The transfer of the data can be initiated from the first computing device 201 and/or the second computing device 202. Additionally, the data can be transferred from the first computing device and/or from another device connected to the second computing device 202.

The compiling program application (e.g., compiler 207) can then manipulate the data to accomplish the compiling function. In the example shown in FIG. 2, the compiler 207 can access the JCL files to identify instructions to accomplish the compiling function. Through execution of the instructions, the compiler 207 can use the source code 216, object code 218, copy members 217, and listing files 219 to compile the program application designed by the developer on the first computing device 201.

Once the program application is compiled, other processing functions can be implemented on the compiled program application or the compiled program application can be transferred back to the first computing device or to another device for viewing by the developer and/or further processing.

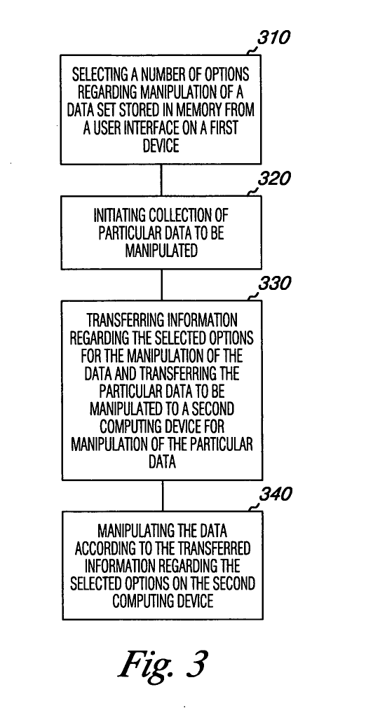

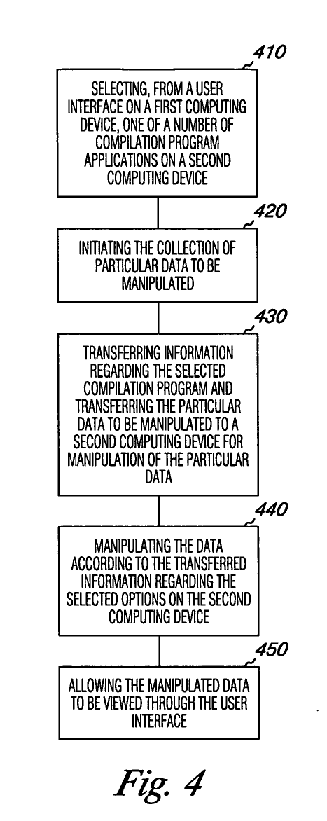

FIGS. 3 and 4 illustrate various method embodiments for dividing the execution of compiling program application functions between computing devices. As one of ordinary skill in the art will understand, the embodiments can be performed by software, application modules, and computer executable instructions operable on the systems and devices shown herein or otherwise.

The embodiments of the invention, however, are not limited to any particular operating environment or to software written in a particular programming language. Software, application modules and/or computer executable instructions, suitable for carrying out embodiments of the present invention, can be resident in one or more devices or locations or in several and even many locations.

Unless explicitly stated, the method embodiments described herein are not constrained to a particular order or sequence. Additionally, some of the described method embodiments or elements thereof can occur or be performed at the same point in time.

FIG. 3 illustrates one method embodiment of dividing the execution of compiling program application functions between computing devices. As shown at block 310 in the embodiment of FIG. 3, the method includes selecting a number of options regarding compiling of a data set stored in memory from a user interface on a first device.

Selecting a number of options can, for example, include selecting a type of compiling program application from a number of compiling program application types provided on the second computing device. Those skilled in the art will understand that there are many types of compiling program applications that can be used with the various embodiments of the present invention.

At block 320, the method further includes initiating the collection of particular data to be compiled. The method of FIG. 3 further includes, transferring information regarding the selected options for the compiling of the data and transferring the particular data to be compiled to a second computing device for compiling of the particular data, at block 330.

At block 340, the method further includes compiling the data according to the transferred information regarding the selected options on the second computing device. In various embodiments, the method can further include transferring data and information to a redundant third computing device. The third computing device can be used as a backup of the data in case the data is lost or damaged during the compiling process, or can be used for parallel processing of some of the compiling functions.

Embodiments can also include presenting the compiled data for viewing through the user interface. In some embodiments, the method can include storing the compiled data for further processing. Further processing can include linkage editing, executing, and other such processes, such as those described above with respect to FIG. 2.

As stated above, first, second, and third computing devices can include mainframe computers, PCs, servers, and the like. In some embodiments, the method can also include compiling the data according to the transferred information regarding the selected options on the third computing device. In this way, the third computing device can act as a back-up for the second computing device or can be used to further expedite the processing of the data through parallel processing.

FIG. 4 illustrates another method embodiment for allocating remote resources for performing compiling functions. As shown at block 410 in the embodiment of FIG. 4, the method includes selecting, from a user interface on a first computing device, one of a number of compilation program applications on a second computing device.

Examples of compiling program applications include, but are not limited to, compiling program applications for developing program applications in various programming language types including Java, C, Enterprise Generation Language (EGL), COBOL, PL/I, C++, FORTRAN, CA-Easytrieve, and CA-Optimizer, programming languages, to name a few. In various embodiments, a number of options regarding the compiling of the particular data through a user interface can be selected on the first computing device.

The method also includes initiating the collection of particular data to be compiled, at block 420. At block 430, the method also includes transferring information regarding the selected compilation program and transferring the particular data to be compiled to a second computing device for compiling of the particular data. Those skilled in the art will understand that the information and data can be transferred in various manners. Examples of how the information and data can be transferred include, but are not limited to a wireline connection, including a T1, T3, USB, or serial connection; or a wireless connection, including infrared, Bluetooth, RF, and other such communication media.

The method of FIG. 4 further includes, compiling the data according to the transferred information regarding the selected options on the second computing device, at block 440. At block 450, the method also includes, allowing the compiled data to be viewed through the user interface.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the invention.

It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes any other applications in which the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A device for dividing the execution of program application functions for software development, comprising:
a processor;
memory coupled to the processor; and
program instructions stored in memory and executable by the processor to:
receive a data set and a selection of options, made through a user interface on a second device, regarding how the data set is to be compiled; and
compile the selected data set based upon the selection of options.

2. The device of claim 1, wherein the device includes program instructions to transfer the compiled data set back to the second device.

3. The device of claim 1, wherein the device includes program instructions to allow the compiled data to be viewed through a user interface on the second device.

4. The device of claim 1, wherein the device includes program instructions for allowing transparent access by a user via the second device.

5. The device of claim 1, wherein the device includes program instructions for compiling a program application from the received data set.

6. The device of claim 1, wherein the device includes program instructions for designing a report from the received data set.

7. The device of claim 1, wherein the device includes program instructions for developing a program application from the received data set.

8. A system for dividing the execution of program application functions between computing devices for software development, comprising:
a first computing device including program instructions to provide user interface functionality for a selection of options regarding compiling of a data set stored in memory on the first computing device; and
a second computing device including program instructions to compile the selected data set stored on the first computing device and transferred to the second computing device based upon the selection of options.

9. The system of claim 8, wherein the second computing device includes program instructions to allow the compiled data to be viewed through the user interface.

10. The system of claim 8, wherein the second computing device includes program instructions to transfer the compiled data set back to the first computing device

11. The system of claim 10, wherein the first computing device includes program instructions to allow the compiled data to be viewed through the user interface.

12. The system of claim 8, wherein the first and second computing devices transfer the data set via a private network.

13. The system of claim 8, wherein the first and second computing devices transfer the data set via an Internet connection.

14. The system of claim 8, wherein the first computing device has multiple user interfaces each corresponding to a different compiling program application.

15. The system of claim 14, wherein the second computing device includes program instructions to compile data from the first computing device for each different compiling program application.

16. The system of claim 8, wherein the user interface functionality is a mirror of a user interface provided by the program instructions on the second computing device.

17. A method of dividing the execution of program application functions between computing devices for software development, comprising:
selecting a number of options regarding compiling of a data set stored in memory from a user interface on a first device;
initiating collection of particular data to be compiled;
transferring information regarding the selected options for the compiling of the data and transferring the particular data to be compiled to a second computing device for compiled of the particular data; and
compiling the data according to the transferred information regarding the selected options on the second computing device.

18. The method of claim 17, wherein selecting a number of options includes selecting a type of program application from a number of program application types provided on the second computing device.

19. The method of claim 18, wherein selecting an application for compiling a program application in a language selected from the group including;
Java;
C; and
Enterprise Generation Language (EGL);
SSP Facility; and
CA-Optimizer.

20. The method of claim 17, further including presenting the manipulated data for viewing through the user interface.

21. The method of claim 17, further including storing the manipulated data for further processing.

22. The method of claim 21, wherein further processing includes linkage editing and executing.

23. A computer readable medium having instructions for causing a device to perform a method, comprising:
selecting a number of options regarding compiling of a data set stored in memory from a user interface on a first device;
initiating collection of particular data to be compiled;
transferring information regarding the selected options for the compiling of the data and transferring the particular data to be compiled to a second computing device for compiling of the particular data; and
compiling the data according to the transferred information regarding the selected options on the second computing device.

24. The computer readable medium of claim 23, wherein transferring data and information to a second computing device includes transferring data and information to a mainframe computer.

25. The computer readable medium of claim 23, wherein the method further includes transferring the data and information to a redundant third computing device.

26. The computer readable medium of claim 25, wherein the method further includes compiling the data device according to the transferred information regarding the selected options on the third computing device.

27. A method for allocating remote resources for performing compiling functions, comprising:
selecting, from a user interface on a first computing device, one of a number of compilation program applications on a second computing device;
initiating the collection of particular data to be compiled;
transferring information regarding the selected compilation program and transferring the particular data to be compiled to a second computing device for compiling of the particular data; and
compiling the data according to the transferred information regarding the selected options on the second computing device; and
allowing the compiled data to be viewed through the user interface.

28. The method of claim 27, wherein the method further includes selecting a number of options regarding the compiling of the particular data through a user interface on the first computing device.

29. The method of claim 27, wherein selecting a compiling program application includes selecting an application for compiling a program application in a language selected from the group including;
COBOL;
PL/I;
C++;
FORTRAN; and
CA-Easytrieve.

30. The method of claim 27, wherein transferring the information and data includes transferring data on a wireline connection.

31. The method of claim 30, wherein transferring data on a wireline connection includes transferring data via a T1.

32. The method of claim 31, wherein transferring data on a T1 connection includes transferring data via a file transfer protocol (FTP).
